(19) United States
(12) Patent Application Publication
(10) Pub. No.: US 2009/0189514 A1
(43) Pub. Date: Jul. 30, 2009

(54) LUMINESCENT MATERIAL

(75) Inventors: Ryosuke Hiramatsu, Kawasaki-shi (JP); Naotoshi Matsuda, Chigasaki-shi (JP)

Correspondence Address: TUROCY & WATSON, LLP, 127 Public Square, 57th Floor, Key Tower, CLEVELAND, OH, 44114, US

(73) Assignee: KABUSHIKI KAISHA TOSHIBA, Tokyo (JP)

(21) Appl. No.: 12/388,067

(22) Filed: Feb. 18, 2009

Related U.S. Application Data
(63) Continuation of application No. PCT/JP2008/071177, filed on Nov. 14, 2008.

(30) Foreign Application Priority Data
Jan. 29, 2008 (JP) 2008-018037

(51) Int. Cl. H01J 1/62; C09K 11/59

(52) U.S. Cl. 313/503; 252/301.4 F

(57) ABSTRACT

A lithium calcium silicate luminescent material is provided, which includes a tetragonal crystal phase containing Li, Ca, Si and O, and an activator containing Eu. The luminescent material exhibits a peak wavelength of emission spectrum falling within a wavelength region of 470 to 490 nm when excited by light having an emission peak falling within a wavelength region of 360 to 460 nm.

### CROSS-REFERENCE TO RELATED APPLICATIONS

This is a Continuation Application of PCT Application No. PCT/JP2008/071177, filed Nov. 14, 2008, which was published under PCT Article 21(2) in English.

This application is based upon and claims the benefit of priority from prior Japanese Patent Application No. 2008-018037, filed Jan. 29, 2008, the entire contents of which are incorporated herein by reference.

### BACKGROUND OF THE INVENTION

1. Field of the Invention

This invention relates to a luminescent material and also to a light-emitting device.

2. Description of the Related Art

A light-emitting diode (LED) is generally constituted by a combination of an LED chip acting as an exciting light source with a luminescent material, and emits various luminescent colors, depending on this combination. For a white LED device which emits white light, there is employed a combination of an LED chip, which emits a light having a wavelength ranging from 360 to 500 nm, and a luminescent material.

For example, there is a combination of an LED chip, which emits a light in the ultraviolet or near-ultraviolet region, and a mixture of luminescent materials. This mixture of luminescent materials may be composed of a blue luminescent material, a green or yellow luminescent material and a red luminescent material. It is required for the luminescent material to be used in a white LED device to be not only capable of effectively absorbing the light ranging from near-ultraviolet region to blue region, i.e. a wavelength of 360 to 500 nm, which corresponds to the emission wavelength of an LED chip acting as an exciting light source, but also capable of efficiently emitting visible light.

For example, a BaMgAl₁₀O₁₇:Eu luminescent material is proposed in JP-A 2007-39517 (KOKAI) as a blue luminescent material to be employed in a white LED device. However, this blue luminescent material is accompanied with a problem that when it is employed in combination with an LED chip which emits a light in the near-ultraviolet region having a wavelength ranging from 380 to 410 nm, the emission intensity greatly changes depending on the peak wavelength of an exciting light source to be employed. For this reason, it is required to adjust the quantity of the blue luminescent material being used in conformity with the variability of the emission wavelength of the LED chip to be used.

There has been also proposed a Li₂(Sr_{0.88}, Ca_{0.1}, Eu_{0.02})SiO₄ luminescent material as a europium-activated lithium alkaline earth metal silicate luminescent material. For example, JP-A 2006-232906 (KOKAI) describes that this luminescent material can be combined with a blue LED acting as a light source to create white light.

### BRIEF SUMMARY OF THE INVENTION

A lithium calcium silicate luminescent material according to one aspect of the present invention comprises a tetragonal crystal phase containing Li, Ca, Si and O; and an activator containing Eu.

A lithium calcium silicate luminescent material according to another aspect of the present invention comprises a crystal phase containing Li, Ca, Si and O; and an activator containing Eu, the luminescent material exhibiting a peak wavelength of emission spectrum falling within a wavelength region of 470 to 490 nm when excited by light having an emission peak falling within a wavelength region of 360 to 460 nm.

A light-emitting device according to a further aspect of the present invention comprises a light-emitting element emitting light having a main emission peak in a wavelength ranging from 360 to 460 nm; and

a luminescent layer comprising a luminescent material and designed to be irradiated with the light, at least a portion of the luminescent material being a first luminescent material formed of the aforementioned luminescent material.

### BRIEF DESCRIPTION OF THE SEVERAL VIEWS OF THE DRAWING

FIG. 1 is a graph showing an emission spectrum of the conventional luminescent material and an emission spectrum of the luminescent material according to one embodiment;

FIG. 2 shows an emission spectrum of the luminescent material according to another embodiment;

FIG. 3 shows an emission spectrum of the luminescent material according to a further embodiment;

FIG. 4 shows an emission spectrum of the luminescent material according to a further embodiment;

FIG. 5 shows an excitation spectrum of the luminescent material according to a further embodiment;

FIG. 6 shows an X-ray diffraction pattern of the luminescent material according to a further embodiment;

FIG. 7 shows an X-ray diffraction pattern of the luminescent material according to the prior art;

FIG. 8 shows a microphotograph obtained from the excitation of the luminescent material by a light having a wavelength of 365 nm according to a further embodiment;

FIG. 9 is a cross-sectional view illustrating a light-emitting device according to one embodiment;

FIG. 10 is a cross-sectional view illustrating a light-emitting device according to another embodiment;

FIG. 11 is an enlarged cross-sectional view of a light-emitting element;

FIG. 12 is a cross-sectional view illustrating a light-emitting device according to a further embodiment;

FIG. 13 shows an emission spectrum of the white LED light-emitting device according to one embodiment; and

FIG. 14 shows an emission spectrum of the white LED light-emitting device according to another embodiment.

### DETAILED DESCRIPTION OF THE INVENTION

Next, various embodiments will be explained. The embodiments described below are simply examples of the luminescent materials and the light-emitting devices each embodying the technical concept of the present invention, so that the present invention should not be construed as being limited to the following embodiments.

Further, the constituent components described in the claims accompanied herewith should not be construed as being limited to those described in the following embodiments. The dimensions, specific materials, configurations and relative arrangement of the constituent members described in the following embodiments are set forth merely for the purpose of explanation and hence should not be construed as limiting the scope of the present invention. Incidentally, the size and relative position of the members shown in the drawings are exaggerated in some cases for the convenience of explanation. In the following explanations, the same or like members are identified by the same designation or the same symbol, thereby omitting the repetition of detailed explanation thereof. Further, each of elements constituting the present invention may be modified in such a manner that a plurality of elements are integrated by the same single member to enable this single member to have the functions of the plurality of elements or, on the contrary, the functions of a single member are shared by a plurality of members.

As a result of extensive studies and research made by the present inventors, it has been found out a lithium calcium silicate luminescent material which exhibits a peak wavelength of emission spectrum which falls within a wavelength region of 470 to 490 nm when excited by light having an emission peak falling within a wavelength region of 360 to 460 nm. In this specification, the term “lithium calcium silicate luminescent material” means a luminescent material having a crystal phase containing Li, Ca, Si and O. Since this luminescent material contains europiums as an activator and is formed of a tetragonal crystal phase, the luminescent material according to one embodiment emits light when excited by the light having a luminescence peak falling within a wavelength range of 360 to 460 nm.

This lithium calcium silicate can be represented generally by the following general formula (B).

LiₐCa_{b}Si_{c}O_{d} (B)

Since “a”, “b”, “c” and “d” can be regarded as being in a substantially stoichiometric composition ratio as long as they are confined within the range shown below, there is no possibility that the emission efficiency can be prominently deteriorated. Incidentally, an accurate stoichiometric composition ratio of these subscripts is: a=2, b=1, c=1 and d=4.

1.9≦a≦2.1 (3);

0.9≦b≦1.1 (4);

0.9≦c≦1.1 (5);

3.9≦d≦4.2 (6);

The ultraviolet-emitting LED emitting a light having a short wavelength of less than 360 nm is high in manufacturing cost and low in conversion efficiency of electricity to light. Moreover, since the resin in which the luminescent material is dispersed tends to be prominently degraded, the lower limit of the excitation wavelength is practically confined to 360 nm. On the other hand, if this LED is excited by a light having a wavelength of more than 460 nm, it is scarcely possible to obtain a target emission spectrum, so that the upper limit of the excitation wavelength is confined to 460 nm.

Incidentally, by the term “emission spectrum”, it is intended to mean herein a spectrum wherein a half band width of emission band to be measured at a wavelength region of a peak wavelength ranging from 470 to 490 nm is confined within 40 nm. This emission spectrum can be determined by exciting a luminescent material by a light having an emission peak in a wavelength region of 360 to 460 nm to generate the emission of light, which is then measured by a spectrophotometer, thus determining the emission spectrum. As the exciting source, it is possible to employ, for example, a near-ultraviolet region LED of 390 nm in wavelength or a blue region LED of 460 nm in wavelength. As the spectrophotometer, it is possible to employ, for example, IMUC-7000 (trade name, Ohtsuka Electronics Co., Ltd.).

The lithium calcium silicate luminescent material according to one embodiment can be represented generally by the following general formula (A).

Liₐ(Ca_{1-x1-y1}, Mₓ₁, Eu_{y1})_{b}Si_{c}O_{d} (A)

In this general formula (A), the content of Eu (y1) is larger than 0. In the case where Eu is not contained therein (y1=0), even if the luminescent material is excited by a light having an emission peak falling within the range of 360-460 nm, it would be impossible to obtain an emission spectrum. On the other hand, if the content of Eu is excessively large, a concentration quenching phenomenon generates, thereby possibly weakening the emission intensity of the Liₐ(Ca_{1-x1-y1}, Mₓ₁, Eu_{y1})_{b}Si_{c}O_{d} luminescent material. In order to avoid this problem, the upper limit in content of Eu (y1) should be regulated to 0.08. Further, the content y1 should more preferably be confined to the range of 0.01≦y1≦0.06.

The luminescent material according to one embodiment exhibits an emission spectrum wherein the half band width thereof is confined within 40 nm and a peak wavelength falls within a wavelength region of 470 to 490 nm when excited by light having an emission peak falling within a wavelength region of 360 to 460 nm. Further, as a result of the measurement by powder X-ray diffractometry (XRD), it was possible to confirm that the crystal structure of the luminescent material according this embodiment was of a tetragonal system. It was found out by the present inventors that this crystal structure was derived due to the content of each of the elements and that the color of emission to be derived therefrom was also closely related to this crystal structure.

With respect to examples of the europium-activated lithium alkaline earth metal silicate luminescent material, there has been conventionally known Li₂(Sr_{0.88}, Ca_{0.1}, Eu_{0.02})SiO₄. Since it is possible to obtain white light through the combination of this luminescent material with a blue LED acting as a light source, the color of emission to be derived from this Li₂(Sr_{0.88}, Ca_{0.1}, Eu_{0.02})SiO₄ is yellow. When the content of Sr, which is an alkaline earth metal, is increased in the same parent composition as described above, the crystal structure is made hexagonal. Namely, it is assumed that when the crystal structure is made hexagonal in the europium-activated lithium alkaline earth metal silicate luminescent material, yellow emission is generated.

As described above, the europium-activated lithium alkaline earth metal silicate luminescent materials which have been known up to date are limited to those which emits only yellow. The fact that the color of emission can be changed depending on the crystal structure thereof is not recognized up to date and is discovered for the first time by the present inventors. Namely, the present inventors have discovered the fact that as the ratio of Ca among the alkaline earth metal elements in the parent composition is increased, the crystal structure thereof is turned hexagonal, enabling it to emit a blue light. More specifically, when the content of Ca (1-x1-y1) is increased to 0.59 or more in the aforementioned general formula (A), it is possible to obtain blue emission.

Incidentally, as shown in the aforementioned general formula (A), part of the calcium site may be substituted by a bivalent cation (M) selected from barium, strontium and magnesium. In the lithium calcium silicate, Ca and M (M is at least one selected from Ba, Sr and Mg) exist in a state of a complete solid solution. Among the substituent elements, Sr and Ca can be present as the same bivalent cation and the ionic radium thereof are relatively close to each other. Because of this, the influence thereof on the crystal structure is relatively small and hence can be preferably employed as a substituent element. On the other hand, Eu to be employed as an activating element is larger in ionic radius than that of Ca. Therefore, Mg, which is smaller in ionic radius than that of Ca, can be preferably employed in a case where the quantity of substitution is relatively small or where the concentration of the activating element is relatively high. In view of these reasons, Sr or Mg is preferable for use as the M.

When the content of M (x1) is too large, the crystal structure to be obtained can no longer be hexagonal. As a result, even if the luminescent material is excited with a light having an emission peak falling within the wavelength region of 360-460 nm, it would be impossible to obtain blue emission. In the case where the substituent element is Sr, the luminescent material to be obtained would become such that it emits yellow having a peak wavelength falling in the vicinity of 575 nm.

In the case where Sr is employed as the M, the content thereof (x1) should preferably be confined to 0.39 or less, more preferably 0.2 or less.

Since the ionic radius of Ba differs greatly from that of Ca, there is a limit in the quantity of Ba that can be incorporated in the Li₂CaSiO₄ employed as a parent body. The upper limit of the content (x1) should be set to 0.2. In the case of Ba, x1 should more preferably be confined to 0.2 or less.

Further, in the case of Mg, the content (x1) thereof should preferably be confined to 0.4 or less, more preferably 0.05 or less.

As long as the deterioration of light-emitting characteristics is not brought about, the lithium site may be substituted, in a small quantity, by at least one selected from sodium, potassium, rubidium and cesium. Likewise, the silicon site may be substituted by a small quantity of germanium.

The content of each of these elements in the luminescent material according to one embodiment can be analyzed, for example, by the following procedures. In the analysis of a metal element such as Ca, M, Eu and Si, the luminescent material synthesized is subjected to alkali fusion. The fused material thus obtained is then subjected to analysis by an ICP emission spectrochemical method which is an internal standard method and by IRIS Advantage (trade name, Thermo Fisher Scientific K.K.) or SPS1200AR (trade name, SII Nanotechnology Inc.) for example. Further, in the analysis of non-metal element “O”, the synthesized luminescent material is subjected to inert gas fusion. The fused material is then analyzed by infrared absorption using, for example, TC-600 (trade name, LECO Co., Ltd.). In this manner, the composition of the luminescent material can be determined.

The luminescent material according to the embodiment described above can be combined with a light-emitting element having an emission peak falling within a wavelength region of 360-460 nm to obtain an LED light-emitting device representing one embodiment. Since a lithium calcium silicate luminescent material of a specific composition containing Eu as an activator is included in the emission layer, the LED light-emitting device according to this embodiment is enabled to enhance the emission efficiency and color rendering as compared with an LED light-emitting device using a conventional luminescent material.

The luminescent material according to one embodiment can be manufactured by employing the following method, for example. As the starting material, it is possible to employ the oxide powder or carbonate powder of the constituent elements. A starting material is weighed to obtain a predetermined quantity thereof to which a crystal growth-promoting agent is added and mixed together by, for example, a ball mill, etc. As the raw material for Eu, it is possible to employ, for example, Eu₂O₃, etc. As the raw material for Ca, it is possible to employ, for example, CaCO₃, CaO, etc. As the raw material for Ba, it is possible to employ, for example, BaCO₃, BaO, etc. As the raw material for Sr, it is possible to employ, for example, SrCO₃, SrO, etc. Further, as the raw material for Mg, it is possible to employ, for example, MgCO₃, MgO, etc. As the raw material for Si, it is possible to employ, for example, SiO₂, etc.

Starting materials such as oxides are formulated in conformity with the composition ratio of the compound aimed at. These raw material powders can be mixed together by a dry mixing method wherein no solvent is employed. Alternatively, it is also possible to employ a wet mixing method wherein an organic solvent such as ethanol is employed.

As the crystal growth-promoting agent, it is possible to employ the chlorides, fluorides, bromides or iodides of alkaline metals. It is also possible to employ the chlorides, fluorides, bromides or iodides of alkaline earth metals and chlorides, fluorides, bromides or iodides of ammonium chloride. In order to prevent any increase in hygroscopic property of the luminescent material, the content of these crystal growth-promoting agents should preferably be confined to the range of 0.01 wt % to 0.3 wt % based on a total weight of these feedstock powders.

A mixed raw material obtained from the mixing of these feedstock powders is placed in a vessel such as a crucible and then subject to heat treatment to obtain a sintered product. The heat treatment can be performed in air, N₂/H₂ or Ar/H₂ atmosphere. By performing the heat treatment in any of these atmospheres, it is possible to prevent any increase in the hygroscopic property of the raw materials and to synthesize a matrix of a luminescent material, and, at the same time, it is possible to promote the reduction of europium in the oxides employed as feedstocks. The conditions for the heat treatment are preferably 600-1000° C. in temperature and 2-48 hours in treatment time. When the treating temperature is too low or when the treating time is too short, it may become difficult to sufficiently achieve the reaction of raw material powders. On the other hand, when the treating temperature is too high or when the treating time is too long, the sublimation of feedstock powders or the product may occur.

The sintered product thus obtained may be subsequently pulverized to obtain the powder thereof, which is again placed in a vessel and subjected to secondary sintering in an N₂/H₂ or Ar/H₂ atmosphere. As the pulverization on the occasion secondary sintering, there is no particular regulation, so that the blocks of product of primary sintering may be pulverized in a mortar, etc., so as to increase the surface area thereof.

By the aforementioned method, Li₂CaSiO₄ wherein the content of Eu was: y1=0, was manufactured. Since Eu was not included in this product, this material was not a luminescent material. Further, a Li₂(Sr_{0.96}, Eu_{0.04})SiO₄ luminescent material, wherein the content of Eu was: y1=0.04 and the content of Sr was: x1=0.96, was manufactured. This luminescent material was formulated to contain Sr at a content of: x1>0.4 and hence confirmed as having a hexagonal crystal structure as measured by XRD.

Further, an Li₂(Ca_{0.96}, Eu_{0.04})SiO₄ luminescent material, wherein the content of Eu was: y1=0.04, was manufactured. This luminescent material was formulated to contain Eu as an activator and hence confirmed as having a tetragonal crystal structure as measured by XRD. Therefore, this material was a luminescent material according to one embodiment.

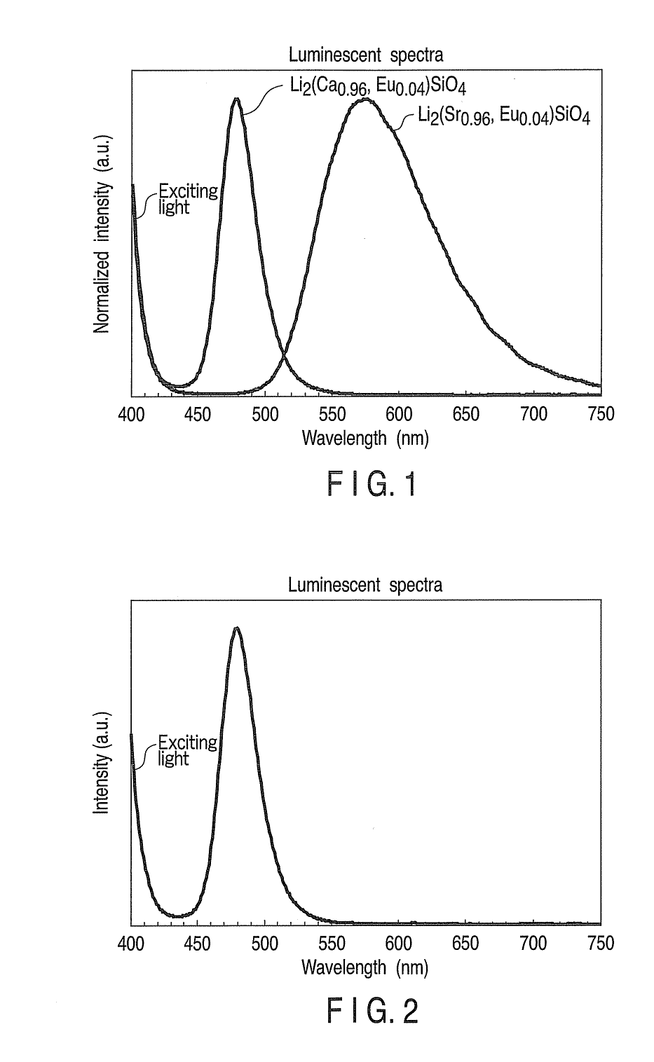

The luminescent materials thus obtained were excited by a near-ultraviolet LED exhibiting a wavelength of 389 nm to measure the emission spectrum thereof. The results are shown in FIG. 1. As shown in FIG. 1, it was possible to derive from the Li₂(Ca_{0.96}, Eu_{0.04})SiO₄ luminescent material an emission spectrum originating from Eu²⁺ and exhibiting a peak wavelength of 480 nm and a half band width of 30 nm. Although not shown in FIG. 1, it was impossible to obtain any emission spectrum from the Li₂CaSiO₄. Further, a yellow emission having a peak wavelength of 575 nm and a half band width of 130 nm was obtained from the Li₂(Sr_{0.96}, Eu_{0.04})SiO₄ luminescent material.

Generally, in the case of the luminescent material which has been activated by divalent europium, as the ionic radius of the element to be substituted by europium becomes larger in a situation where the crystal structure thereof is formed of the same parent crystal, the peak wavelength more likely shift toward the short wavelength side. The reason for this may be attributed to the fact that the influence of atoms closely surrounding the substituted europium on the substituted europium becomes smaller in such a situation. Namely, the reason may be assumably attributed to the fact that since the influence of the crystal field becomes smaller, the energy partitioning of the 5d level of europium becomes smaller.

Incidentally, it is generally known that the ionic radius of strontium is larger than the ionic radius of calcium. In the case of the luminescent material activated with Eu according to one embodiment, the Li₂(Sr, Eu)SiO₄ luminescent material employing strontium exhibits a peak wavelength at a longer wavelength region than the Li₂(Ca, Eu)SiO₄ luminescent material where calcium is employed. The reason for this may be attributed to a difference in peripheral environments of europium between the Li₂(Ca, Eu)SiO₄ luminescent material and the Li₂(Sr, Eu)SiO₄ luminescent material. Namely, because of the difference in crystal structure between the Li₂(Ca, Eu)SiO₄ luminescent material and the Li₂(Sr, Eu)SiO₄ luminescent material, the Li₂(Ca, Eu)SiO₄ luminescent material exhibits quite a different emission characteristic from that of the Li₂(Sr, Eu)SiO4 luminescent material.

The europium-activated luminescent material having a composition of Li₂CaSiO₄ as a parent body is formed of a tetragonal crystal structure and enabled to have a relatively large space around the europium as compared with a hexagonal crystal structure. Because of this, this europium-activated luminescent material generates a blue to green emission. As described above, the phenomenon that the emission color of an alkaline earth metal silicate luminescent material changes depending on the crystal structure thereof was first discovered by the present inventors.

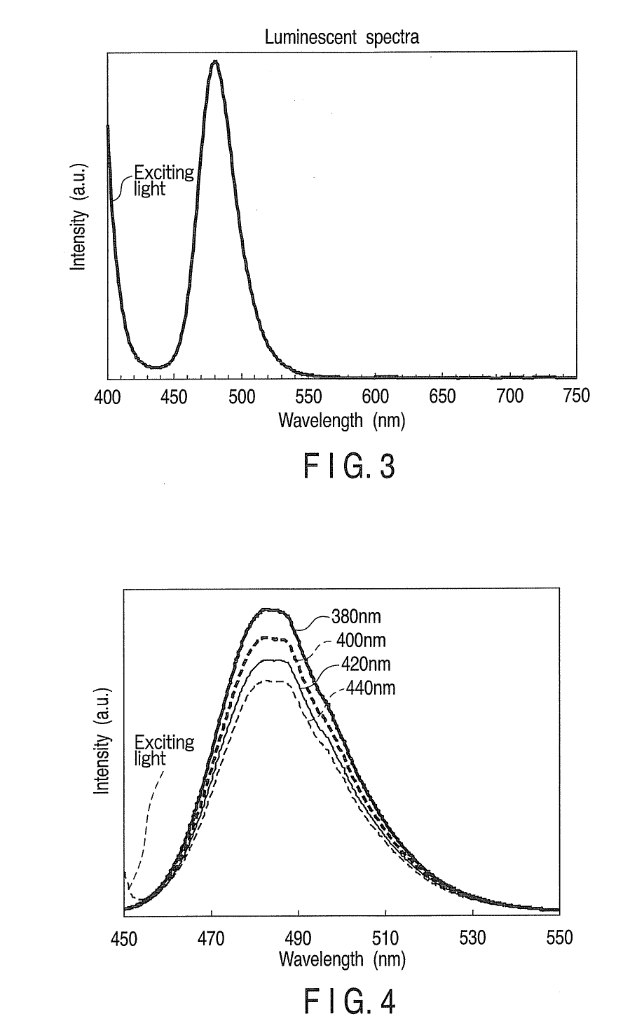

Further, an Li₂(Ca_{0.99}, Eu_{0.01})SiO₄ luminescent material and an Li₂(Ca_{0.912}, Sr_{0.048}, Eu_{0.04})SiO₄ luminescent material were manufactured respectively according to the aforementioned method. The luminescent materials thus obtained were excited by a near-ultraviolet LED exhibiting a peak wavelength of 391 nm and the emission spectrums thus obtained were measured. The results are shown in FIGS. 2 and 3, respectively.

As shown in FIG. 2, it was possible, through the excitation with a near-ultraviolet ray, to derive an emission originating from Eu²⁺ and exhibiting a peak wavelength of 479 nm and a half band width of 32 nm from the Li₂(Ca_{0.99}, Eu_{0.01})SiO₄ luminescent material. Further, as shown in FIG. 3, it was possible, through the excitation with a near-ultraviolet ray, to derive an emission originating from Eu²⁺ and exhibiting a peak wavelength of 480 nm and a half band width of 33 nm from the Li₂(Ca_{0.912}, Sr_{0.048}, Eu_{0.04})SiO₄ luminescent material.

Next, by an exciting light having a different wavelength, the Li₂(Ca_{0.96}, Eu_{0.04})SiO₄ luminescent material was excited and the resultant emission spectrum was measured. In this case, the wavelength of the exciting light employed was varied to 380, 400, 420 and 440 nm. The emission spectrums obtained through the employment of these exciting lights are shown in FIG. 4. It will be recognized that in any case where any one of these wavelengths was employed for the excitation, it was possible to confirm blue emission from the Li₂(Ca_{0.96}, Eu_{0.04})SiO₄ luminescent material. Further, as the exciting light was made longer in wavelength, the intensity of emission was lowered. However, as far as the exciting wavelength region of 380 to 440 nm is concerned, it was only possible to confirm the lowering in intensity of emission to about 25%.

As described above, in the case of the emission spectrum to be obtained from the luminescent material of this embodiment, the variation in intensity of emission was confined within 40% as the luminescent material was excited by a light having an emission peak falling within the range of 360 to 460 nm. This variation is very small as compared with the conventional blue luminescent material such as a BaMgAl₁₀O₁₇:Eu luminescent material. For example, in the case of the BaMgAl₁₀O₁₇:Eu luminescent material, the variation in intensity of emission increases up to 75% even if the exciting wavelength is confined to a narrow range of 370 to 420 nm.

Because of this, when this BaMgAl₁₀O₁₇:Eu luminescent material is employed in combination with an LED chip which emits light of the near-ultraviolet region having a wavelength ranging from 380 to 410 nm, the emission intensity of the luminescent material greatly varies depending on the peak wavelength of the exciting light source. Moreover, due to the variability of emission wavelength of the LED chip to be used, it may be sometimes required to adjust the quantity of the blue luminescent material to be used.

Whereas, in the case of the blue luminescent material according to one embodiment, the variation in intensity of emission that may be caused depending on the exciting wavelength is relatively small as described above. Because of this, the quantity of the blue luminescent material is not required to be adjusted even if the emission wavelength of the LED chip to be used is varied, thus making this luminescent material very easy in handling.

The luminescent material having a composition represented by the aforementioned general formula (A) was measured with respect to the excitation spectrum thereof. As a result, it was possible to confirm the existence of an excitation band in the vicinity of 470 nm and in the peripheral region of the emission peak wavelength. The excitation spectrum can be obtained by measuring a luminescent material powder by diffusion scattering using, for example, a fluorospectrophotometer F-3000 (trade name, Hitachi Ltd.).

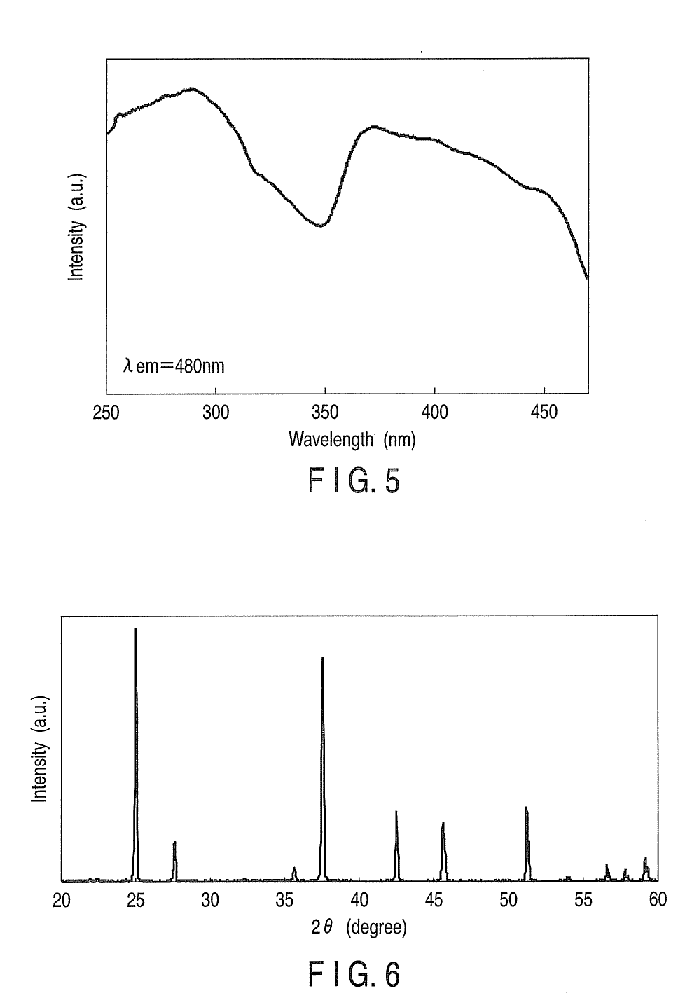

FIG. 5 shows an excitation spectrum which was obtained through the observation of the emission of 480 nm of the Li₂(Ca_{0.96}, Eu_{0.04})SiO₄ luminescent material. It will be recognized from FIG. 5 that the Li₂(Ca_{0.96}, EU_{0.04})SiO₄ luminescent material was capable of being excited at the wavelength range of 250-470 nm. Further, it will be also recognized that the changes in exciting spectrum were moderate in the wavelength region of 360 to 460 nm. Due to the moderate changes of the exciting spectrum, the rate of change in emission intensity was also minimized even if the exciting spectrum was caused to change in the wavelength region of 360 to 460 nm.

In order to identify the crystal phase of the Li₂(Ca_{0.99}, Eu_{0.01})SiO₄ luminescent material and of the Li₂(Sr_{0.96}, Eu_{0.04})SiO₄ luminescent material, these luminescent materials were measured with respect to the diffraction pattern thereof by powder X-ray diffractometry (XRD). Then, the diffraction patterns obtained were compared with JCPDS (Joint Committee on Powder Diffraction Standards) cards, thereby performing the identification of the crystal phase.

In this XRD measurement, a sample of the synthesized luminescent material is measured with respect to the diffraction pattern by, for example, M18XHF²²-SRA (trade name, Mac/Science Company Co., Ltd. (Blueker AXS K.K.)) and then, the resultant diffraction pattern is compared with that of the JCPDS card.

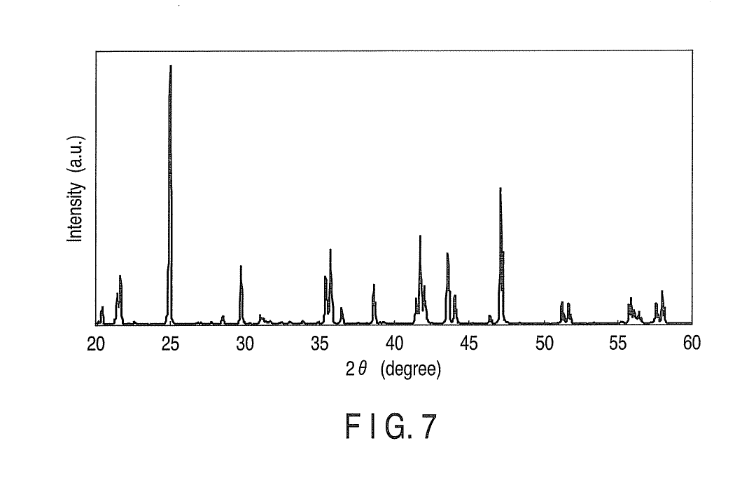

In order to obtain an X-ray diffraction pattern, the Li₂(Ca_{0.99}, Eu_{0.01})SiO₄ luminescent material and the Li₂(Sr_{0.96}, Eu_{0.04})SiO₄ luminescent material were subjected to the XRD measurement. FIGS. 6 and 7 show the resultant X-ray diffraction patterns, respectively. The diffraction pattern obtained was found to be approximately identical with the diffraction pattern of tetragonal system Li₂CaSiO₄ phase shown in the JCPDS card #27-290. It will be recognized from this result that in the case of the Liₐ₁(Ca_{1-x1-y1}, Mₓ₁, Eu_{y1})_{b1}Si_{c1}O_{d1} luminescent material, which is activated by europium, the components Ca and Eu were all included therein in a state of solid-solution.

Further, the diffraction patterns obtained from the Li₂(Sr_{0.96}, Eu_{0.04})SiO₄ luminescent material was found to be approximately identical with the diffraction pattern of hexagonal system Li₂SrSiO₄ phase shown in the JCPDS card #55-217.

If the diffraction pattern of the luminescent material having a composition represented by the aforementioned general formula (A) has a peak which is identical with the peak of the tetragonal Li₂CaSiO₄ phase in the XRD measurement as described above, it can be said that the tetragonal Li₂CaSiO₄ phase has been generated therein.

Since the luminescent material thus synthesized has a structure wherein an activating element Eu as well as an additive element such as M, etc. is incorporated therein as a substituent element, the diffraction peak to be obtained from the XRD measurement will be affected by the change of lattice constant that may be caused due to ionic radius of the substituting elements. For this reason, the diffraction pattern to be obtained may not be accurately identical to the diffraction pattern of Li₂CaSiO₄ phase described in the JCPDS card #27-290. However, even if the 2θ thereof is shifted in peak by several degrees, the diffraction pattern thus obtained can be regarded as being identical to the diffraction pattern of Li₂CaSiO₄ phase. A similar peak shift may generate in the substitution of a monovalent cation element for the lithium site or in the substitution of a tetravalent cation element for the silicon site.

Further, observation by a fluorescence microscope was performed on the Li₂(Ca_{0.96}, Eu_{0.04})SiO₄ luminescent material. This microscopic observation was performed in such a manner that a synthesized sample of luminescent material was excited by irradiating it with an exciting light having a wavelength of 365 nm to generate the emission from the luminescent material, which emission was observed by ECLIPSE80i (trade name, Nikon Corporation) for example. It was confirmed from the results of the observation using the fluorescence microscope that the synthesized Li₂(Ca_{0.96}, Eu_{0.04})SiO₄ luminescent material was formed of particles having a particle diameter ranging from around 5 to 30 μm and uniformly emitting blue light due to the irradiation thereof with an exciting light having a wavelength of 365-435 nm.

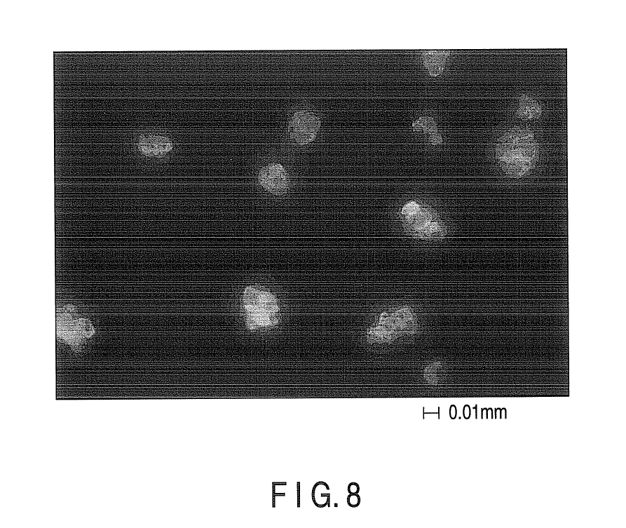

FIG. 8 shows the results of the microscopic observation of the Li₂(Ca_{0.96}, Eu_{0.04})SiO₄ luminescent material as it was irradiated with an exciting light having a wavelength of 365 nm.

The luminescent material according to this embodiment can be manufactured, basically, by a process wherein various raw materials powder are mixed together and then subjected to sintering as described above. The luminescent material thus sintered should preferably be subjected to any appropriate post-treatment, such as washing with pure water, on the occasion of applying the luminescent material to an emission device, etc. Even in this washing, the quenching of the Liₐ₁(Ca_{1-x1-y1}, Mₓ₁, Eu_{y1})_{b1}Si_{c1}O_{d1} luminescent material can be scarcely recognized, indicating that this luminescent material is quite stable. Namely, since the luminescent material according to this embodiment is stable in an air atmosphere as well as in an aqueous solution, the degree of freedom with regard to the post-treatment to be performed on a sample after the sintering thereof is very high.

If required for the purpose of preventing moisture, a surface-covering material may be coated on the surface of luminescent particles manufactured. The surface-covering material to be employed herein may be formed of at least one selected from the group consisting of silicone resin, epoxy resin, fluororesin, tetraethoxy silane (TEOS), silica, zinc silicate, aluminum silicate, calcium polyphosphate, silicone oil and silicone grease. Zinc silicate and aluminum silicate may be represented, for example, by ZnO.cSiO₂ (1≦c≦4) and Al₂O₃.dSiO₂ (1≦d≦10), respectively.

The surface of the luminescent particles need not be completely covered with the surface-covering material, so that part of the surface of the luminescent particles may be exposed. As long as the surface-covering material made of the aforementioned materials is present on the surface of the luminescent particles, it is possible to derive the effects thereof. This surface-covering material can be applied to the surface of the luminescent particles by a fluid dispersion containing the surface-covering material or by use of a solution of the surface-covering material. Specifically, the luminescent particles are immersed in the fluid dispersion or the solution for a predetermined period of time and then dried by heating, etc., thus depositing the surface-covering material on the surface of luminescent particles. In order to secure the effects of the surface-covering material without deteriorating the inherent functions of the luminescent particles, the quantity of the surface-covering material should preferably be confined to about 0.1-5% by volume based on the luminescent particles.

Further, the luminescent material according to this embodiment is classified depending on the coating method to be applied to an emission device. For example, for an ordinary white LED where an exciting light of 360-460 nm in wavelength is employed, the luminescent material is employed after the luminescent material has been classified into 5 to 50 μm or so. If the particle diameter of luminescent material is too small, such as 1 μm or less, the ratio of the non-emission surface layer may be undesirably increased, thus deteriorating the intensity of emission. On the other hand, if the particle diameter of luminescent material is too large, a coating device may be clogged with the luminescent material on the occasion of coating the luminescent material onto an LED, thus not only deteriorating the yield but also giving rise to the discoloration of the emission device to be obtained. In order to overcome these problems, the luminescent materials according to this embodiment should preferably be employed after the classification thereof within the range of 5 to 50 μm or so.

As described above, it is possible, through the excitation of a lithium calcium silicate luminescent material which is activated with europium by an exciting light having a peak wavelength falling within the region of 360-460 nm, to obtain the emission of light originating from europium at a wavelength region with the half band width thereof being confined to at most 40 nm and a peak wavelength falling within the range of 470 to 490 nm. Further, it is possible, through the combination of the luminescent material of this embodiment with an emission element exhibiting an emission peak falling within the region of 360-460 nm in wavelength, to obtain an emission device which is high in efficiency and in color rendering. As the emission element, either an LED chip or a laser diode may be employed.

The luminescent material according to this embodiment is a bluish luminescent material. Therefore, it is possible to obtain a white light-emitting device as this luminescent material is employed in combination with a yellow luminescent material. A white light-emitting device can be obtained even when this bluish luminescent material is employed in combination with a greenish luminescent material and a reddish luminescent material, or even when this bluish luminescent material is employed in combination with a yellowish luminescent material and a reddish luminescent material. For example, in a case where a light source of the near-ultraviolet region is employed, the luminescent material according to this embodiment can be employed in combination with a greenish luminescent material and a reddish luminescent material, thereby making it possible to provide a white light-emitting device.

The greenish luminescent material or the yellowish luminescent material can be defined as being a luminescent material having a major emission peak in a wavelength region ranging from 510 to 580 nm. For example, it is possible to employ silicate luminescent materials such as (Sr, Ca, Ba)₂SiO₄:Eu, Ca₃(Sc, Mg)₂Si₃O₁₂:Ce, CaSc₂O₄:Ce, etc.; aluminate luminescent materials such as (Y, Gd)₃(Al, Ga)₅O₁₂:Ce, BaMgAl₁₀O₁₇:Eu,Mn, etc.; sulfide luminescent materials such as (Ca, Sr, Ba)Ga₂S₄:Eu, etc.; alkaline earth oxynitride luminescent materials such as (Ca, Sr, Ba)Si₂O₂N₂:Eu, etc.; and rare earth silicate nitride luminescent materials such as (Y, La, Gd, Lu)₂Si₃O₃N₄:Tb,Ce, (La, Y, Gd, Lu)₃Si₈O₄N₁₁:Tb,Ce, etc. Incidentally, by the term “major emission peak”, it is intended to mean a wavelength at which the peak intensity of the emission spectrum as reported so far in the prior documents or patent publications becomes the largest. The fluctuation of emission peak of around 10 nm due to the addition of a small amount of an element or due to slight changes in composition on the occasion of manufacturing the luminescent material may be regarded as being the major emission peak that has been reported so far.

The red luminescent material can be defined as being a luminescent material having a major emission peak in a wavelength region ranging from orange to red and having a wavelength of 580 to 680 nm. As examples of the red luminescent material, it is possible to employ, for example, silicate luminescent materials such as (Sr, Ca, Ba)₂SiO₄:Eu, etc.; tungstate luminescent materials such as Li(Eu, Sm)W₂O₈, etc.; oxyfluoride luminescent materials such as 3.5MgO.0.5MgF₂.GeO₂:Mn⁴⁺, etc.; oxide luminescent materials such as YVO₄:Eu, etc.; oxysulfide luminescent materials such as (La, Gd, Y)₂O₂S:Eu, etc.; sulfide luminescent materials such as (Ca, Sr, Ba)S:Eu, etc.; and nitride luminescent materials such as (Sr, Ba, Ca)₂Si₅N₈:Eu, (Sr, Ca)AlSiN₃:Eu, etc.

Other than the aforementioned luminescent materials, it is also possible to employ an orange luminescent material, depending on the applications thereof.

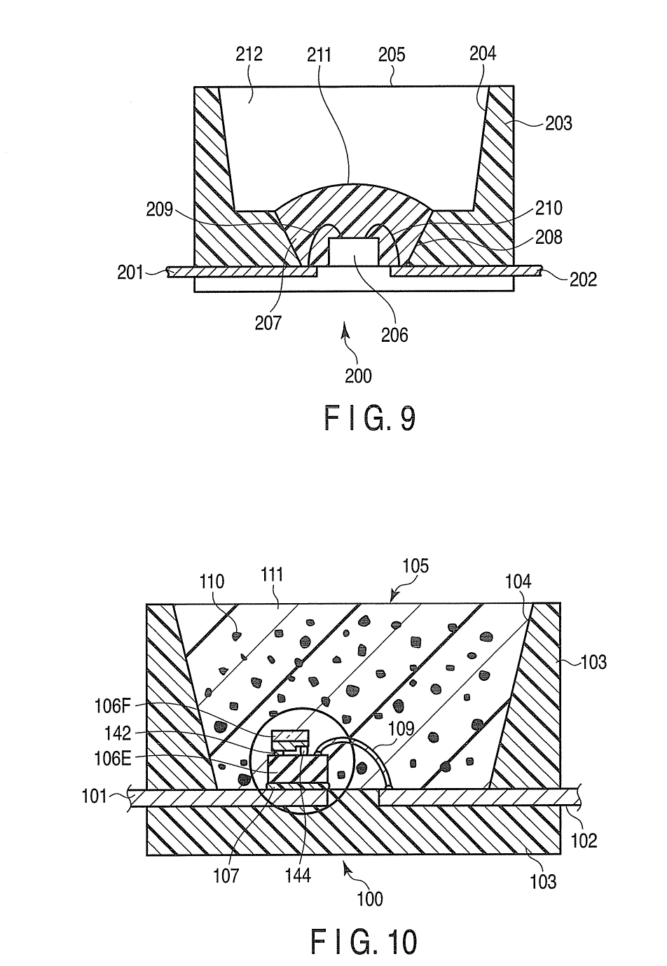

The emission device shown in FIG. 9 is constituted by a resin stem 200. This resin stem 200 comprises two leads 201 and 202 constituting a lead frame and a resin portion 203 which is formed integral with the lead frame. This resin portion 203 is provided with a recess 205 having an upper opening which is wider than the bottom thereof. This recess is provided, on the sidewall thereof, with a reflective surface 204.

A light-emitting chip 206 is mounted on a central portion of the approximately circular bottom of the recess 205 by an Ag paste, etc. As the light-emitting chip 206, it is possible to employ those which are capable of emitting an ultraviolet ray or light of the visible region. For example, it is possible to employ a GaAs-based or a GaN-based semiconductor light-emitting diode, etc. The electrodes (not shown) of the light-emitting chip 206 are connected, through bonding wires 207 and 208 made of Au and the like, with the lead 201 and the lead 202, respectively. Incidentally, the arrangement of these leads 201 and 202 can be optionally modified.

A luminescent layer 209 is disposed in the recess 205 of the resin portion 203. This luminescent layer 209 can be formed by dispersing the luminescent material 210 of this embodiment in a resin layer 211 made of, for example, silicone resin at a ratio ranging from 5 to 50 wt %. The luminescent material can be adhered by various kinds of binders, such as an organic material, a resin for example, or an inorganic material, such as glass.

As the binder formed of an organic material, it is suitable to use a transparent resin which is highly light-proof, such as epoxy resin, acrylic resin other than the aforementioned silicone resin. As the binder formed of an inorganic material, it is suitable to use a low-melting glass wherein alkaline earth borate, etc. is employed; an ultra-fine powder of silica or alumina, etc. for enabling the luminescent material of a relatively large grain size to be adhered; or an alkaline earth phosphate that can be obtained by sedimentation. These binders may be employed singly or in combination of two of more kinds.

The luminescent material to be employed in the luminescent layer may be applied with surface-coating as required. This surface-coating is effective in preventing the luminescent material from being deteriorated by external factors such as heat, moisture and ultraviolet rays. Further, this surface-coating is also effective in adjusting the dispersibility of the luminescent material, thus facilitating the design of the luminescent layer.

As the light-emitting chip 206, it is also possible to employ a flip-chip structure wherein an n-type electrode and a p-type electrode are both disposed on the same surface thereof. In this case, it is possible to overcome the problems accompanied with wiring, such as the cut-off or peeling of wire and the absorption of light by the wire, thereby making it possible to obtain a semiconductor light-emitting device which is excellent in reliability and in luminance. Further, an n-type substrate may be employed for forming the light-emitting chip 206, thus fabricating the following structure. More specifically, an n-type electrode is formed on the underside of the n-type substrate and a p-type electrode is formed on the top surface of the semiconductor layer on the substrate with either the n-type electrode or the p-type electrode being mounted on the lead. In this case, the n-type electrode or the p-type electrode may be connected with the other lead by wire. The size of the light-emitting chip 206 as well as the size and configuration of the recess 205 may be optionally modified.

The emission device shown in FIG. 10 comprises a resin stem 100, a semiconductor light-emitting element 106F mounted on the resin stem 100, and a sealing body 111 covering the semiconductor light-emitting element 106F. The resin stem 100 comprises two leads 101 and 102 constituting a lead frame and a resin portion 103 which is formed integral with the lead frame. These leads 101 and 102 are disposed in such a manner that one end of each of these leads faces close to the other. The other end of each of these leads is extended in a direction opposite to the other and protruded out of the resin portion 103.

The resin portion 103 is provided with an opening 105, on the bottom of which a protective Zener diode 106E is mounted by an adhesive 107. On this protective Zener diode 106E is mounted a semiconductor light-emitting element 106F. Namely, a diode 106E is mounted on the lead 101. A wire 109 is connected at one end thereof with the diode 106E and at the other end with the lead 102.

The semiconductor light-emitting element 106F is surrounded by the inner walls of the resin portion 103. The inner walls are inclined in the light-extracting direction, thereby enabling them to act as a reflective surface 104 for reflecting light. The sealing body 111 filled in the opening 105 contains a luminescent material 110. The semiconductor light-emitting element 106F is laminated on the protective Zener diode 106E. As the luminescent material 110, a luminescent material according to this embodiment can be employed.

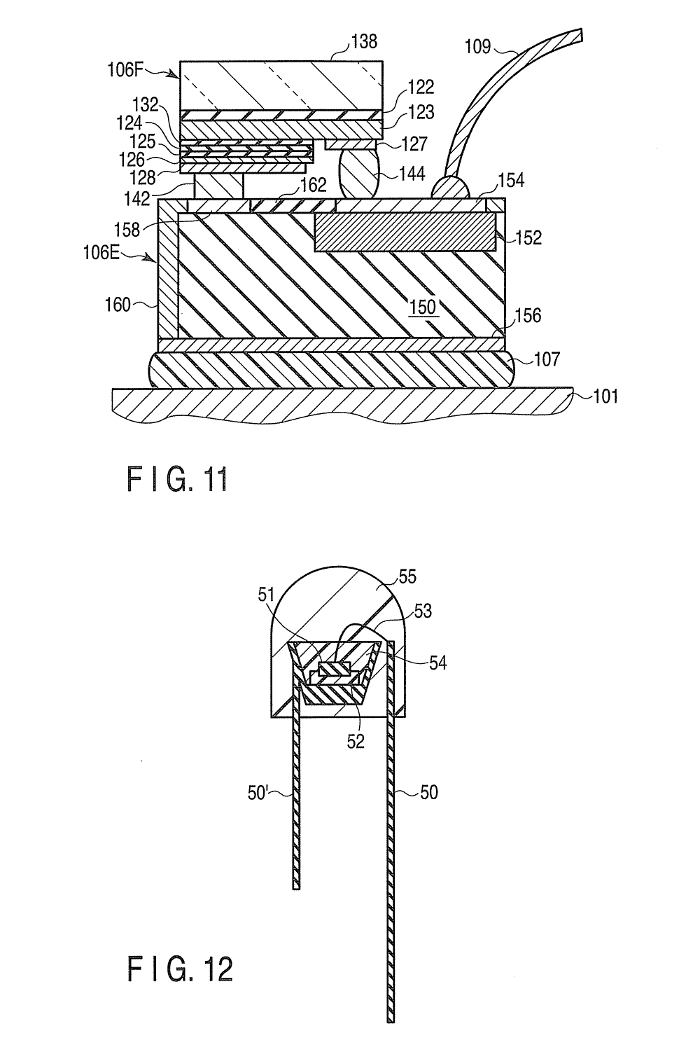

Next, the peripheral portion of the chip of light-emitting device will be explained in detail. As shown in FIG. 11, the protective Zener diode 106E is formed of a planar structure wherein a p-type region 152 is formed on the surface of an n-type silicon substrate 150. A p-side electrode 154 is formed in a p-type region 152 and an n-side electrode 156 is formed on the underside of the substrate 150. In reverse to this n-side electrode 156, an n-side electrode 158 is formed also on the top surface of the Zener diode 106E. These two n-side electrodes 156 and 158 are connected with each other through a wiring layer 160 which is provided on the sidewall of the Zener diode 106E. Further, a high reflection film 162 is formed on the top surface of the Zener diode 106E on which the p-side electrode 154 and the n-side electrode 158 are provided. This high reflection film 162 is a film which exhibits a high reflectance to the light to be emitted from the light-emitting element 106F.

In the semiconductor light-emitting element 106F, a buffer layer 122, an n-type contact layer 123, an n-type clad layer 132, an active layer 124, a p-type clad layer 125 and a p-type contact layer 126 are successively laminated on a translucent substrate 138. Further, an n-side electrode 127 is deposited on the n-type contact layer 123, and a p-side electrode 128 is deposited on the p-type contact layer 126. The light emitted from the active layer 124 is taken up through the translucent substrate 138.

The light-emitting element 106F constructed in this manner is flip-chip-mounted via a bump on the diode 106E. Specifically, the p-side electrode 128 of the light-emitting element 106F is electrically connected through a bump 142 with the n-side electrode 158 of the diode 106E. Further, the n-side electrode 127 of the light-emitting element 106F is electrically connected through a bump 144 with the p-side electrode 154 of the diode 106E. One end of a wire 109 is bonded to the p-side electrode 154 of the diode 106E and the other end of the wire 109 is connected with the lead 102.

In this shell-type light-emitting device shown in FIG. 12, a semiconductor light-emitting element 51 is mounted, through a mounting material 52, on a lead 50′ and covered with a pre-dipping material 54. By a wire 53, a lead 50 is connected with the semiconductor light-emitting element 51 and the resultant composite body is sealed with a casting material 55. The luminescent material according to this embodiment is contained in the pre-dipping material 54.

As described above, a light-emitting device, for example a white LED, according to this embodiment employs a blue luminescent material exhibiting a narrow-band emission spectrum. Because of this, the light-emitting device according to this embodiment is most suited for use not only as an ordinary illumination substituting for a fluorescent lamp, but also as a luminescence device where a filter such as a color filter is used in combination with a light source, for example, as a light source for the backlight of a liquid crystal device. For a conventional white LED, since it is combined with a luminescent material of a broad band emission and enabled to emit light of a broad-band spectrum throughout the entire visible light region, it is accompanied with a problem that when the white LED is employed in combination with a color filter, most of the light volume of the white LED employed as a light source is absorbed by the filter.

Whereas, in the case of the white LED according to this embodiment, since it can be combined with a light exhibiting a spectrum of a narrow half-band width, it is possible to efficiently utilize a specific wavelength when employed in combination with a filter. Especially, when rare earth silicate nitride luminescent materials such as (Y, La, Gd, Lu)₂Si₃O₃N₄:Tb,Ce, (La, Y, Gd, Lu)₃Si₈O₄N₁₁:Tb,Ce, etc. are employed as a green luminescent material, and oxyfluoride luminescent materials such as 3.5MgO.0.5MgF₂.GeO₂:Mn⁴⁺, etc. or oxysulfide luminescent materials such as (La, Gd, Y)₂O₂S:Eu, etc. are employed as a red luminescent material, not only the blue component to be derived from the luminescent material of this embodiment but also the green component and the red component are enabled to emit a spectrum of a narrow half-band width, thereby making it possible to efficiently utilize the white light that can be emitted from the light-emitting device. More specifically, the light-emitting device according to this embodiment is most suited for use as a backlight of a liquid crystal device.

Next, although the present invention will be explained in detail with reference to Examples and Comparative Examples, it should be noted that the following Examples are not intended to limit the present invention and hence can be variously modified so long as the gist of the present invention is not exceeded.

### EXAMPLE 1

A Li₂(Ca_{0.96}, Eu_{0.04})SiO₄ luminescent material was prepared. As the raw material powder, 14.8 g of Li₂CO₃ powder, 19.2 g of CaCO₃ powder, 12.7 g of SiO₂ powder, and 1.4 g of Eu₂O₃ powder were prepared. Further, 0.3 g of NH₄Cl was employed as a crystal growth promoting agent and these starting materials were uniformly mixed in a ball mill.

The mixed raw material thus obtained was placed in a sintering vessel and sintered under the following sintering conditions. First of all, in a reducing atmosphere of N₂/H₂, the mixed raw material was sintered at a temperature ranging from 700 to 1000° C. for 3-24 hours to obtain a primary sintered product.

This primary sintered product was pulverized and then placed again in a crucible, which was then placed in a furnace. The interior of the crucible was purged with nitrogen in vacuum. Furthermore, the resultant product was again sintered for 2-24 hours in a reducing atmosphere of N₂/H₂ containing hydrogen at a concentration of 5%-less than 99% and at a temperature ranging from 700 to 1000° C. to obtain a secondary sintered product. This secondary sintered product was pulverized in water, sieved and dehydrated by suction filtration.

Finally, the resultant powder was dried at a temperature of 100° C. in a drying oven and then sieved to obtain a luminescent material of this example. When the luminescent material of Example 1 thus obtained was subjected to quantitative analysis by an ICP emission spectrometric method, the luminescent material of this example was confirmed as having a composition corresponding approximately to the raw materials charged.

Further, the content of each of constituent elements was varied as shown in the following Table 1, thus manufacturing the luminescent materials of Examples 2-9 and Comparative Example 1. A BaMgAl₁₀O₁₇:Eu luminescent material which was available in the market was employed as Comparative Example 2. The luminescent material of Comparative Example 1 contained no Ca and was constituted by only Sr. Table 1 shows the peak wavelength of each of the luminescent materials as they were excited at a wavelength of 390 nm, the crystal structures thereof, the peak intensity as they were excited at a wavelength of 380 nm, and changes of peak intensity as they were excited at a wavelength of 420 nm.

TABLE 1

| | Composition of | Peak wavelength | Crystal | Half-band | Peak |
|---|---|---|---|---|---|
| | luminescent materials | (nm) | structure | width (nm) | intensity |
| Ex. 2 | Li₂(Ca_{0.9},Eu_{0.1})SiO₄ | 482 | Tetragonal | 32 | 0.96 |
| Ex. 3 | Li₂(Ca_{0.99},Eu_{0.01})SiO₄ | 479 | Tetragonal | 32 | 0.84 |
| Ex. 4 | Li₂(Ca_{0.912},Sr_{0.048},Eu_{0.04})SiO₄ | 480 | Tetragonal | 33 | 0.88 |
| Ex. 5 | Li₂(Ca_{0.816},Sr_{0.144},Eu_{0.04})SiO₄ | 480 | Tetragonal | 34 | 0.88 |
| Ex. 6 | Li₂(Ca_{0.912},Mg_{0.048},Eu_{0.04})SiO₄ | 480 | Tetragonal | 32 | 0.91 |
| Ex. 7 | Li₂(Ca_{0.594},Mg_{0.396},Eu_{0.01})SiO₄ | 477 | Tetragonal | 32 | 0.93 |
| Ex. 8 | Li₂(Ca_{0.940},Ba_{0.050},Eu_{0.01})SiO₄ | 478 | Tetragonal | 34 | 0.87 |
| Ex. 9 | Li₂(Ca_{0.891},Ba_{0.099},Eu_{0.01})SiO₄ | 476 | Tetragonal | 38 | 0.89 |
| Comp. Ex. 1 | Li₂(Sr_{0.96},Eu_{0.04})SiO₄ | 575 | Hexagonal | 130 | — |
| Comp. Ex. 2 | BaMgAl₁₀O₁₇:Eu | 451 | Hexagonal | 55 | 0.25 |

As explained above with reference to FIG. 1, in the case of the luminescent material of Comparative Example 1, i.e. a conventionally known luminescent material containing no Ca and constituted by only Sr, the crystal structure thereof was hexagonal and found to exhibit yellow emission having a peak wavelength of 575 nm and a half-band width of 130 nm upon excitation with a light of 400 nm in wavelength.

In the case of the luminescent material of Comparative Example 2, i.e. the BaMgAl₁₀O₁₇:Eu luminescent material, there was obtained blue emission having a peak wavelength of 450 nm and a half-band width of 55 nm upon excitation with a light of 400 nm in wavelength. However, when the exciting wavelength was fluctuated from 380 to 420 nm, the ratio of intensity of peak wavelength was lowered by as large as 75%, thus indicating a strong dependency of emission intensity on the exciting wavelength. Because of this, this luminescent material is accompanied with the drawback that, on the occasion of designing it to obtain white light, the quantity of the luminescent material to be incorporated is required to be greatly changed depending on the variability of the exciting light source, etc.

Whereas, in the case of the luminescent materials of Examples, it was possible to obtain blue emission having a peak wavelength of 480 nm and a half-band width of 30 nm upon excitation with a near-ultraviolet ray of 400 nm or so in wavelength. Even if the exciting wavelength was fluctuated from 380 to 420 nm, the ratio of intensity of peak wavelength was lowered by only 16% or so, thus indicating a very weak dependency of emission intensity on the exciting wavelength. Because of this, even if variability in the exciting light source is present, etc., the quantity of the luminescent material to be incorporated is not required to be changed substantially. These results agree with the result obtained from the excitation spectrum of Li₂(Ca_{0.96}, Eu_{0.04})SiO₄ luminescent material of Example 1 shown in FIG. 5.

A (Y, Gd)₃(Al, Ga)₅O₁₂:Ce luminescent material, which was a yellow luminescent material and available in the market, was used in combination with a blue LED chip to manufacture a white LED device. This white LED device was employed as Comparative Example 3. More specifically, as shown in FIG. 10, this LED chip was mounted via a bump on a diode, thus creating a light-emitting device having a so-called flip-chip structure. The content of the luminescent materials of the white LED device of Comparative Example 3 was adjusted so as to regulate the color temperature thereof to 4000K. In this white LED device where the color temperature was adjusted to 4000K, an average color rendering index Ra was 67 (Ra=67). This average color rendering index Ra can be determined from the emission spectrum obtained from the white LED device.

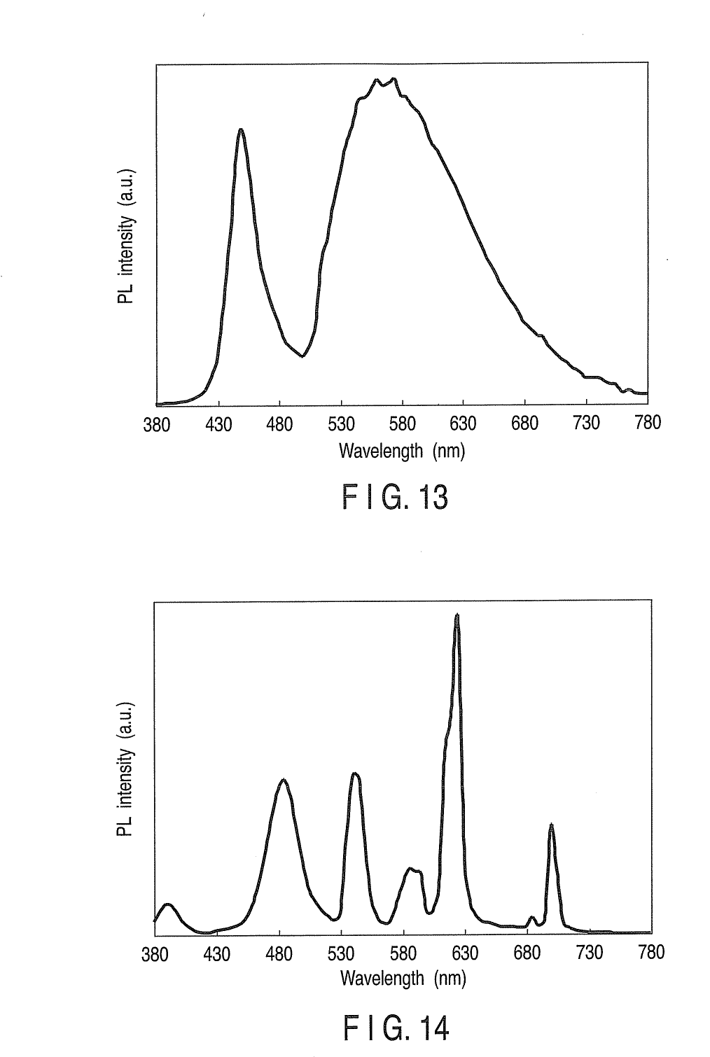

Another resinous mixture was prepared in the same manner as in the case of Comparative Example 3 except that the luminescent material of Example 1 was incorporated therein. Then, a white LED device was manufactured in the same manner as described above except that the resinous mixture thus prepared was employed. This white LED device was employed as Example 13. The mixing ratio of the luminescent materials of the white LED device of Example 13 was adjusted so as to regulate the color temperature thereof to 4000K. The emission spectrum obtained as the color temperature thereof was adjusted to 4000K is shown in FIG. 13. In this white LED device where the color temperature was adjusted to 4000K, an average color rendering index Ra was 69 (Ra=69).

As is apparent from the comparison between Example 13 and Comparative Example 3, the white LED device of Example 13 was more excellent in average color rendering index Ra as compared with that of Comparative Example 3.

The luminescent material of Example 3, a synthesized green luminescent material constituted by a (Y, La, Gd, Lu)₂Si₃O₃N₄:Tb,Ce luminescent material and a red luminescent material available in the market and constituted by a (La, Gd, Y)₂O₂S:Eu luminescent material were mixed together to obtain a mixture of luminescent materials. This mixture was then dispersed in silicone resin to prepare a resinous mixture. The resinous mixture thus obtained was used in combination with a near-ultraviolet LED of 391 nm in peak wavelength to manufacture a white LED light-emitting device. More specifically, a light-emitting device of a surface-mounting structure as shown in FIG. 11 was manufactured, which was identified as Example 14.

The content of the luminescent materials of the white LED device of Example 14 was adjusted so as to regulate the color temperature thereof to 4000K. The emission spectrum obtained as the color temperature thereof was adjusted to 4000K is shown in FIG. 14. In this white LED device where the color temperature was adjusted to 4000K, an average color rendering index Ra was 68 (Ra=68).

According to the embodiment of the present invention, it is possible to provide a blue luminescent material which emits light when excited by a light having an emission peak falling within the range of 360 nm to 460 nm and to provide a light-emitting device employing such a luminescent material.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A lithium calcium silicate luminescent material comprising:
a tetragonal crystal phase containing Li, Ca, Si and O; and
an activator containing Eu.

2. The luminescent material according to claim 1, further comprising M, M being at least one selected from the group consisting of Ba, Sr and Mg.

3. The luminescent material according to claim 2, wherein a molar fraction x1 of the M based on a total number of moles of Ca, M and Eu is confined within the range defined by the following expression (1), and a molar fraction y1 of the Eu based on a total number of moles of Ca, M and Eu is confined within the range defined by the following expression (2):
0≦x1≦0.4 (1);
0<y1≦0.08 (2)

4. The luminescent material according to claim 3, wherein the fraction y1 is confined to the range of 0.01<y1≦0.06.

5. The luminescent material according to claim 3, wherein the luminescent material has a composition represented by the following general formula (A):
Liₐ(Ca_{1-x1-y1}, Mₓ₁, Eu_{y1})_{b}Si_{c}O_{d} (A)
wherein “a”, “b”, “c” and “d” are confined within the ranges shown below:
1.9≦a≦2.1 (3);
0.9≦b≦1.1 (4);
0.9≦c≦1.1 (5);
3.9≦d≦4.2 (6).

6. The luminescent material according to claim 5, wherein “a” is 2, “b” is 1, “c” is 1 and “d” is 4 in the general formula (A).

7. The luminescent material according to claim 5, wherein 1-x1-y1 is 0.59 or more in the general formula (A).

8. The luminescent material according to claim 2, wherein the M is Sr.

9. The luminescent material according to claim 8, wherein the fraction x1 is 0.39 or less.

10. The luminescent material according to claim 2, wherein the M is Ba.

11. The luminescent material according to claim 10, wherein the fraction x1 is 0.2 or less.

12. The luminescent material according to claim 2, wherein the M is Mg.

13. The luminescent material according to claim 12, wherein the fraction x1 is 0.4 or less.

14. The luminescent material according to claim 1, wherein the luminescent material exhibits a peak wavelength of emission spectrum falling within a wavelength region of 470 to 490 nm when excited by light having an emission peak falling within a wavelength region of 360 to 460 nm.

15. The luminescent material according to claim 1, wherein a half-band width of the emission wavelength of the luminescent material is 40 nm or less.

16. A lithium calcium silicate luminescent material comprising:
a crystal phase containing Li, Ca, Si and O; and
an activator containing Eu;
the luminescent material exhibiting a peak wavelength of emission spectrum falling within a wavelength region of 470 to 490 nm when excited by light having an emission peak falling within a wavelength region of 360 to 460 nm.

17. The luminescent material according to claim 16, wherein the crystal phase is of a tetragonal system.

18. A light-emitting device comprising:
a light-emitting element emitting light having a main emission peak in a wavelength ranging from 360 to 460 nm; and
a luminescent layer comprising a luminescent material and designed to be irradiated with the light, at least a portion of the luminescent material being a first luminescent material formed of the luminescent material claimed in claim 1.

19. The light-emitting device according to claim 18, wherein the luminescent layer further comprises a second luminescent material having a peak wavelength ranging from 580 to 680 nm.

20. The light-emitting device according to claim 18, wherein the luminescent layer further comprises a third luminescent material having a peak wavelength ranging from 510 to 580 nm.
